(19) United States
(12) Patent Application Publication
(10) Pub. No.: US 2009/0222781 A1
(43) Pub. Date: Sep. 3, 2009

(54) METHOD FOR DESIGNING CIRCUIT LAYOUT CAPABLE OF PROPAGATING SIGNALS SYNCHRONOUSLY WITHOUT SIGNIFICANT ALTERATION OF LAYOUT

(75) Inventor: Ryoji Hamazaki, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/372,072

(22) Filed: Feb. 17, 2009

(30) Foreign Application Priority Data
Feb. 28, 2008 (JP) 2008-047876

(51) Int. Cl. G06F 9/45

(52) U.S. Cl. 716/6

(57) ABSTRACT

In a circuit layout design method for designing an integrated circuit having signal lines synchronously propagating signals, delay correction cells having provisional values are inserted into the signal lines extending from respective output drivers to corresponding output pads for a set of signals to be synchronized in the designed original circuit. Based on the circuit data having the delay correction cells thus inserted, a layout is designed, based on which resistance values for those respective signal lines are calculated. The resistance value for the respective delay correction cells are corrected so as to equalize the resistance values for those signal lines, and the layout pattern is corrected based on the circuit data having the corrected delay correction cells.

### BACKGROUND OF THE INVENTION

1. Field of the Invention

The present invention relates to a circuit layout design method, for example, a method of arranging circuit elements and wiring signal lines between the circuit elements in a semi-conductor integrated circuit, and more particularly to a circuit layout design method of designing an integrated circuit having signal lines over which signals can synchronously propagate.

2. Description of the Background Art

In the conventional method for designing a layout of circuit elements and wiring thereof in a semi-conductor integrated circuit, in order to design an integrated circuit having signal lines synchronously propagating signals, a circuit layout pattern, when completed in design, is put through test simulations to verify the length of propagation time of signals, and then, if adjustments are necessary, the gate size of a transistor associated with a signal required to be adjusted as well as the length and width of wiring between devices are altered for adjustment of the length of propagation time of the signal.

Such a layout design method is disclosed by Japanese Patent Laid-open Publication No. 306230/1999, for example, wherein a circuit designing/verifying equipment is used for verifying the length of delay time in propagation of an RC (resistance and capacitance) circuit network including connections between resistors and capacitors, and the length of delay time in propagation calculated by applying a predetermined calculation method is corrected with reference to correction comparison data previously formed from a circuit model, in order to reduce the length of verification time.

However, in the conventional method for designing a circuit layout, the layout patterns not only for conveying signals desired to be adjusted but also for conveying signals adjacent thereto have to be altered, and moreover, even the layout patterns of the circuits or connections associated with the patterns thus altered have to be altered, which causes a significant influence so that a number of processes for correcting the layouts have been required. Further, since the alteration of layout patterns will be liable to further affect the propagating signals, it has been necessary to repeat those processes from the alteration of the layout patterns up to the verification of timing several times until obtaining the circuitry having interconnections synchronously propagating the signals.

### SUMMARY OF THE INVENTION

It is an object of the present invention to provide a circuit layout design method for designing an integrated circuit having interconnections over which synchronously conveying signals without significant alteration in circuit layout.

In accordance with the present invention, a method for designing a circuit layout is characterized by performing, in turn, a circuit designing process for inserting delay correction cells between signal lines extending from respective output drivers to corresponding output pads for a set of signal to be synchronized in the designed circuit, a layout designing process for arranging the delay correction cells in the vicinity of the output pads according to the circuit data having the delay correction cells inserted therein as well as for wiring the signal lines between the delay correction cells and the corresponding output drivers, a wiring resistance value calculating process for calculating resistance values for the signal lines extending from the respective output drivers to the corresponding output pads according to the layout patterns obtained from the designing of the layout, a resistance value correcting process for correcting the resistance values for the delay correction cells so as to substantially equalize the resistance values for the signal lines extending from the respective output drivers to the corresponding output pads, and a layout pattern correcting process for correcting the patterns of the delay correction cells in the layout patterns according to circuit data containing the delay correction cells having the resistance values thus corrected.

In accordance with the present invention, layout patterns are formed based on circuit data having delay correction cells inserted into the signal lines extending from respective output drivers to corresponding output pads for a set of signals to be synchronized in the designed circuit of an original circuit under designing, from the layout patterns the resistances of the signal lines being calculated to correct the resistance values for the delay correction cells so as to substantially equalize the resistance values for the signal lines extending from the respective output drivers to the corresponding respective output pads, and then the patterns of the delay correction cells being corrected according to the corrected resistance values. Thus, only the patterns inside the delay correction cells can be corrected to make the resistance values for the respective signal lines substantially equal to each other. It is thus advantageous to design, without significantly altering circuit layouts, an integrated circuit having a set of signal lines that can propagate signals substantially synchronously with each other.

### BRIEF DESCRIPTION OF THE DRAWINGS

The objects and features of the present invention will become more apparent from consideration of the following detailed description taken in conjunction with the accompanying drawings in which:

FIG. 1 is a flowchart showing an embodiment of a circuit layout design method according to the present invention;

FIGS. 2A and 2B schematically show an example of circuit to be designed under the designing process shown in FIG. 1;

FIG. 3 is a schematic block diagram showing an example of delay correction cell included in the circuit shown in FIG. 2;

FIG. 4 schematically shows an example of circuit under the layout designing process shown in FIG. 1;

FIG. 5 shows an example of wiring resistance values and resistance values calculated in the wiring resistance value calculating process and the resistance value correcting process, respectively, shown in FIG. 1; and

FIG. 6 schematically shows an example of circuit layout pattern formed in the layout pattern correcting process shown in FIG. 1.

### DESCRIPTION OF THE PREFERRED EMBODIMENT

A preferred embodiment of a circuit layout design method in accordance with the present invention will be described in detail below with reference to the accompanying drawings. According to the present invention, circuit cells, referred to as “delay correction cells”, which are dedicated to correcting or adjusting signal delay are inserted in advance on a circuit diagram and a circuit layout pattern into the pathways or connections of signals desired to be synchronized, and then the delay correction cells are individually adjusted in terms of the length of propagation time of signals propagating thereover according to a difference in delay time between the propagating signals to be synchronized. The adjustment of the length of propagation time by means of the delay correction cells can be achieved in such a way that the delay correction cells have a circuit pattern of internal resistance and the like incorporated beforehand to serve as parameterized cells capable of controlling delay time by feeding parametric values for resistance and the like to the cells, and then only the pattern of the internal resistances and the like is altered while the profile and size of the cells are kept as they are. All those processes may of course be implemented on a processor system, such as a computer. The invention is thus advantageous specifically in that it is possible to adjust the length of propagation time of a signal without altering a layout pattern once formed, resulting in a reduced number of processes for modifying layout patterns. In the context, the term “circuit” is to broadly be comprehended, specifically in circuit designing or layout sense, so as to cover the possibility of any circuit elements including wiring and connections.

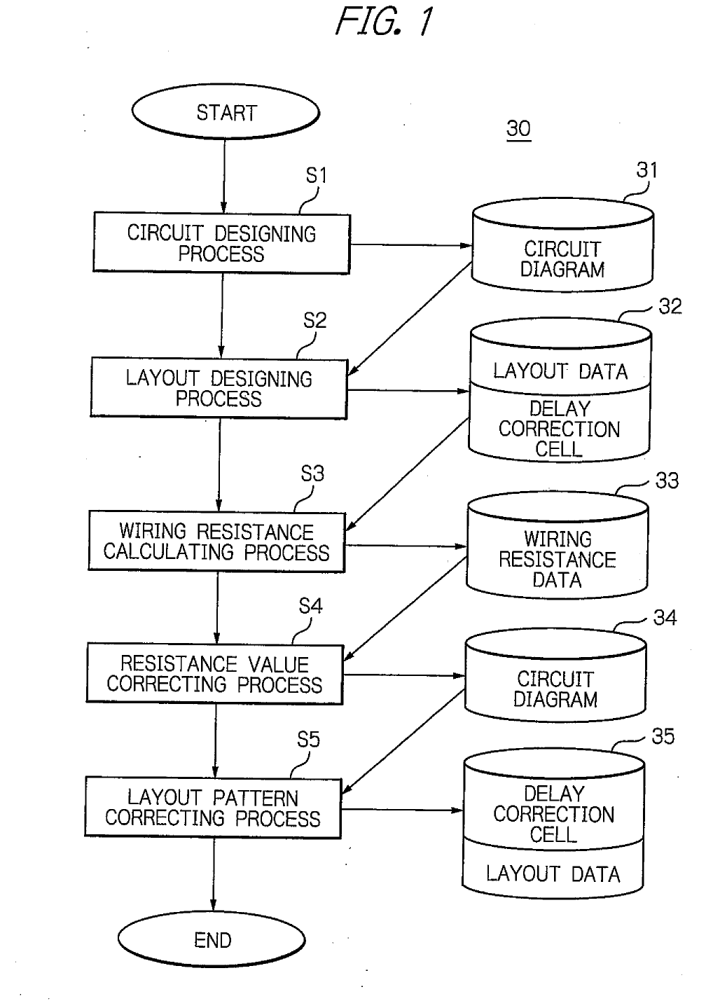

FIG. 1 is a flowchart useful for understanding a specific layout design method of an illustrative embodiment in accordance with the present invention. As seen from FIG. 1, in the illustrative embodiment, there are five process or steps in broad outline, i.e. a circuit designing process or step S1, a layout designing process or step S2, a wiring resistance value calculating process or step S3, a resistance value correcting process or step S4, and a layout pattern correcting process or step S5 in sequence.

In the circuit designing process S1, circuit cells dedicated to correction of delay, i.e. delay correction cells, are inserted into respective signal lines or connections extending from output drivers up to output connector pads for a group of signals desired to be synchronized in a circuit under designing in an original circuit.

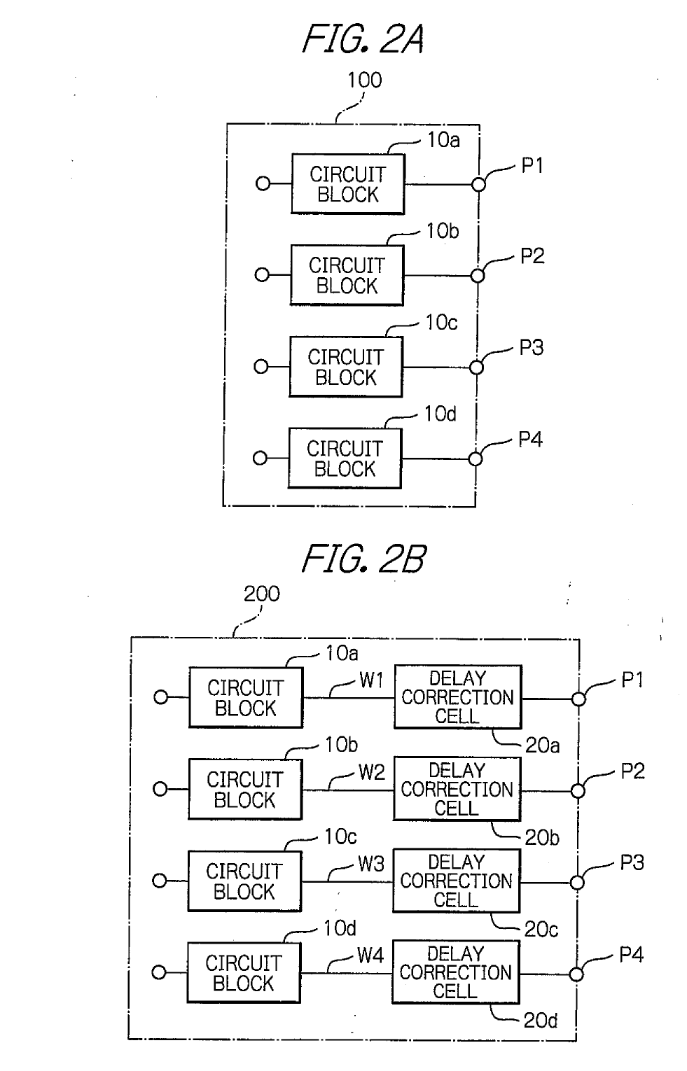

FIGS. 2A and 2B schematically show an example of circuit designing process S1 shown in FIG. 1. As shown in FIG. 2A, an original circuit 100 to be designed is under the designing process S1 so as to develop signals from circuit blocks 10a-10d including output drivers to respective connector pads P1-P4. When the signals to be developed from the circuit blocks 10a-10d to the pads P1-P4 are desired to be coincided in timing with each other, for example, the delay correction cells 20a-20d are added, as shown in FIG. 2B, to the original circuit 100 such that they are inserted between the circuit blocks 10a-10d and the pads P1-P4, respectively, so that a resultant circuit 200 is formed. Of course, the number of signal lines desired to be synchronized shown in FIG. 2 is only illustrative and may be changed as desired.

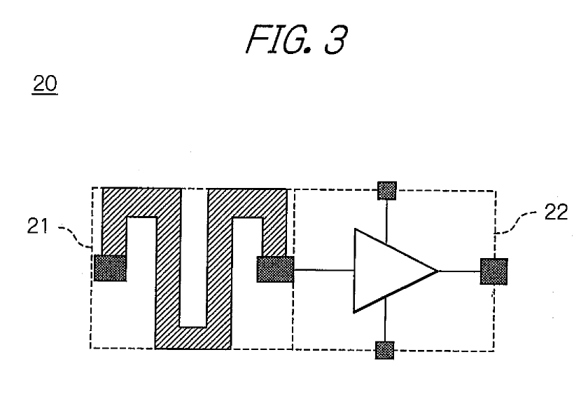

The delay correction cells 20a-20d are parameterized cells and formed in the same shape and size as each other. Also the delay correction cells 20a-20d are the same in circuitry where each of the cells 20a-20d has a resister 21 and a buffer 22 connected in series to each other, for example, as shown in FIG. 3. The resister 21 may have its resistance value implemented as a parameter so that a value of the parameter is given to change a circuit pattern of the resister 21 in width and length within an area set for forming the resister 21. The value of the parameter may fall between the minimum correction resistance value, almost equal to zero, and the maximum resistance value, for example, 1 kΩ, as in practical wiring. Here, the resistance value of the delay correction cells 20a-20d are set to a provisional value R, which may be, for example, 10Ω.

Of course, the configuration of the delay correction cell 20 shown in FIG. 3 is only illustrative and may be changed or modified, as desired. For example, the delay correction cell 20 may be a combination of the resistor 21 and a circuit other than the buffer 22, or it may be a circuit formed only of the resistor 21.

Referring again to FIG. 1, the circuit diagram of the circuit 200 formed in step S1 is once stored as circuit diagram data 31 in a file storage 30 of the processor system, and thereafter the procedure proceeds to the layout designing process or step S2. As noted in FIG. 1, the processor system is partially shown only as the file storage 30.

The layout designing process S2 is performed based on the circuit diagram data 31 of the circuit 200 formed in step S1. The layout designing process S2 may be performed by using, e.g. a common CAD (Computer-Aided Design) tool for automatic disposition and wiring. At this instance, the delay correction cells 20a-20d are specified to be disposed in close proximity to the respective pads P1-P4. The circuit blocks 10a-10d are disposed in position in such a way that they have the corresponding signal lines W1-W4 whose length up to the respective delay correction cells 20a-20d are substantially as equal to each other as possible.

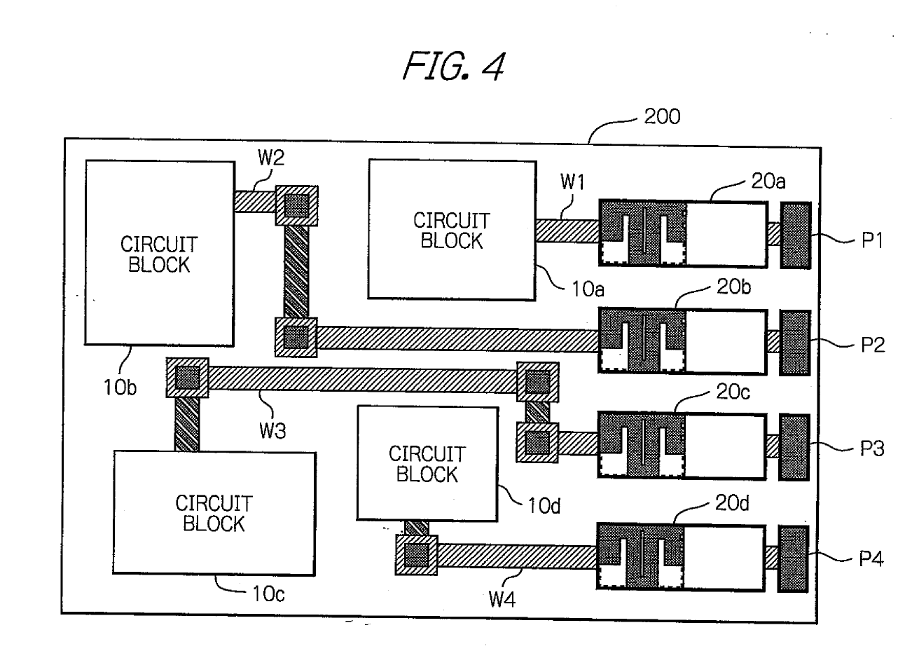

Reference will be made to FIG. 4 for specifically describing an example of circuit including an exemplified layout pattern obtained in the layout designing process or step S2. In the figure, structural parts and elements like those shown in FIG. 2 are designated by identical reference numerals, and will not repetitively be described in order to avoid redundancy.

In FIG. 4, at the rightmost end of the circuit pattern of the circuit 200, there are arranged the connector pads P1-P4 for external connection, and adjacent thereto there are arranged the delay correction cells 20a-20d, respectively. Further, the circuit blocks 10a-10d are disposed more inside the circuit pattern than the cells 20a-20d so that the output signals of the circuit blocks 10a-10d are to be given to the corresponding delay correction cells 20a-20d over wirings W1-W4, respectively.

Referring again to FIG. 1, data of the layout pattern formed in step S2 are once stored as layout data 32 in the file storage 30 of the processor system. Thereafter, the procedure proceeds to the wiring resistance value calculating process or step S3 and further to the resistance value correcting process or step S4.

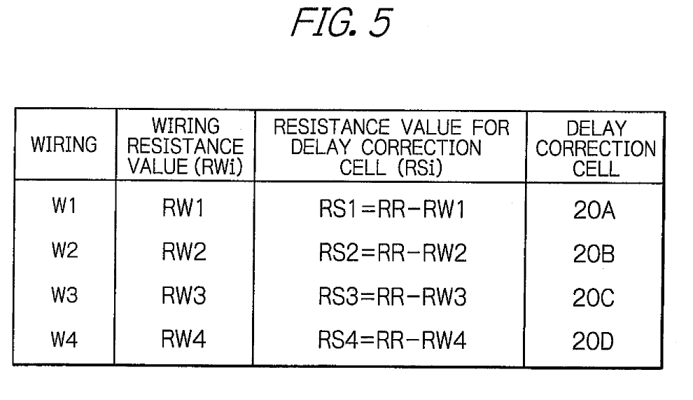

FIG. 5 shows an example of wiring resistance values and resistance values calculated in the wiring resistance value calculating process or step S3 and the resistance value correcting process or step S4, respectively. The wiring resistance value calculating process or step S3 takes place based on the layout data 32 formed in step S2, so that wiring resistance values are calculated.

More specifically, in step S3, the general technique may be used to grasp the wiring length and wiring width of signal lines, i.e. wirings W1-W4 in this example, of the signals desired to be synchronized, and, based on the length and width, the wiring resistance values RW1-RW4 of the respective wirings W1-W4 are calculated. The calculated resistance values RW1-RW4 of the respective wirings W1-W4 are recorded as wiring resistance data 33 in the file storage 30 of the processor system, and thereafter the procedure proceeds to step S4.

In step S4, in order to define the optimal structure of the delay correction cells 20, the resistance value correcting process takes place for re-setting the resistance value for the resistors 21 in the respective delay correction cells 20a-20d.

More specifically, in the resistance value correcting process S4, a reference resistance value RR is first calculated by means of the following expression (1) from the largest of the resistance values RW1-RW4 for the respective wirings W1-W4 obtained in the wiring resistance value calculating process S3 and from the minimum corrected resistance value which is the minimum resistance value formable as the resistor 21 of the delay correction cell 20,

Reference Resistance Value RR=Maximum Wiring Resistance Value+Minimum Corrected Resistance Value (1)

Subsequently, according to the reference resistance value RR and the resistance value RW1 for each wiring W1-W4, resistance values RS1-RS4 corrected by the delay correction cells 20a-20d are calculated according to the following expression (2),

Corrected Resistance Value RSi=Reference Resistance Value PR−Resistance Value RWi (2)

where, i=1-4.

Further, as shown in FIG. 5, according to the resistance values RS1-RS4 thus calculated, the delay correction cells 20a-20d are altered into delay correction cells 20A-20D having those resistance values.

Referring back again to FIG. 1, the circuit diagram comprising the delay correction cells 20A-20D thus altered according to the corrected resistance value RS1-RS4, respectively, is stored as corrected circuit diagram data 34 in the file storage 30 of the processor system, and thereafter the procedure proceeds to the layout pattern correcting process or step S5.

The layout pattern correcting process or step S5 takes place based on the corrected circuit diagram data 34. More specifically, in the layout pattern correcting process S5, the resistor 21 in the delay correction cells 20a-20d is only slightly altered according to the parameters thereof, i.e. to the corrected resistance values RS1-RS4 so that the delay correction cells 20A-20D are formed. Note that the layout patterns of the circuit blocks 10a-10d and the wirings W1-W4 are not altered. Because in the correction process or step S4 only the alteration of the delay correction cells 20a-20d into the delay correction cells 20A-20D having resistance values different from each other has taken place, and also because the delay correction cells 20A-20D have been formed of parameterized cells, the outside dimensions and shapes are still the same as the delay correction cells 20a-20d. The layout data 35 thus corrected in step S5 are stored in the file storage 30.

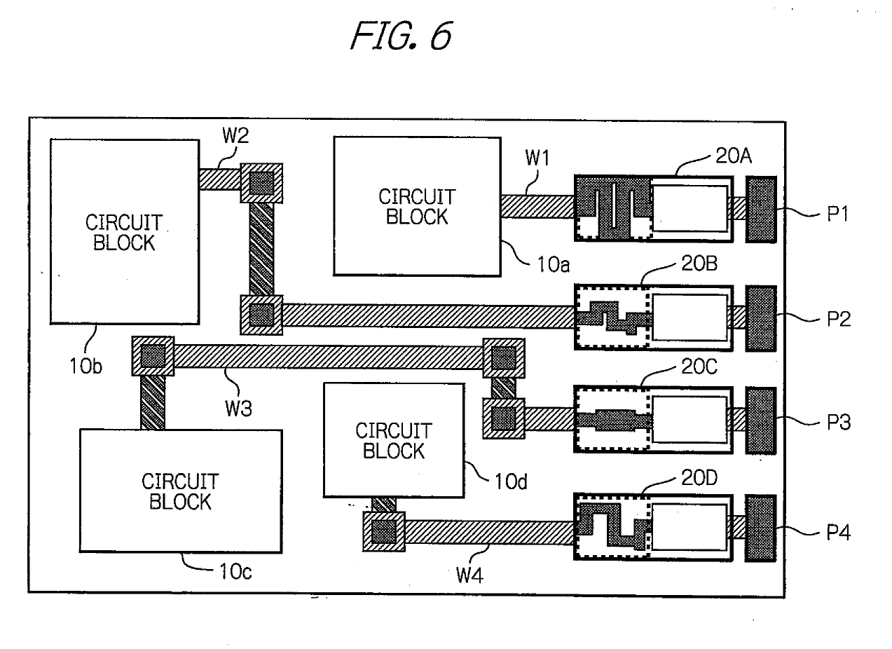

FIG. 6 schematically shows an example of layout pattern corrected with the resistance values in the layout pattern correcting process or step S5. As seen from FIG. 5, in the layout pattern after corrected, only the circuit patterns of the resisters in the delay correction cells 20A-20D have been altered, but no alteration has been made on the layout patterns of the circuit blocks 10a-10d and the wirings W1-W4, as seen from the comparison with the layout patterns before corrected. The resistance of propagation pathways between the output ports of the respective circuit blocks W1-W4 and the corresponding pads P1-P4 takes values resultant from addition of the resistance values RW1-RW4 for the actual wirings W1-W4 and the corrected resistance values RS1-RS4 for the delay correction cells 20A-20D, respectively, the patterns being formed so that the resultant values are substantially equal to each other.

Note that, in the illustrative embodiment, the delay correction cells 20a-20d are parameterized cells so that the resistance patterns are automatically formed based on parameters, while any suitable procedure may be used for forming the resistance patterns. For example, resistance patterns each of which corresponds to one of the resistance values may be stored beforehand in the file storage 30 of the processor system so as to select the corresponding resistance pattern according to a specified resistance value.

In summary, in the layout design method of the illustrative embodiment, the delay correction cells having provisional values are inserted, respectively, into the signal lines extending from respective output drivers to corresponding output pads for a set of signals desired to be synchronized in the designed circuit in the original circuit, so as to design a layout based on the circuit data having the delay correction cells inserted therein, whereupon the resistance values for the signal lines extending from the respective drivers to the corresponding output pads are calculated based on the layout patterns obtained in the layout designing, and the resistance values for the respective delay correction cells are corrected to substantially equalize the resistance values for the signal lines extending from the respective drivers to the corresponding output pads, and then the layout patterns are corrected based on the circuit data having the corrected delay correction cells.

Thus, in the correction of layout patterns, the resistance values for the signal lines extending from the respective output drivers to the corresponding output pads can be substantially equal to each other by correcting only the patterns of the resistances of the delay correction cells. Accordingly, it is an advantage that it is possible to adjust the lengths of propagation time of signals without altering the entire layout patterns once completed, with the result that the correcting processes of accomplishing layout patterns can be reduced which allow propagation signals to be synchronized.

The entire disclosure of Japanese patent application No. 2008-47876 filed on Feb. 28, 2008, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A circuit layout design method for designing on a processor system an integrated circuit including output drivers and a set of signal lines, the signal lines interconnecting the respective output drivers to corresponding output pads and being able to convey signals synchronous with each other, said method comprising the steps of:
inserting a delay correction cell into each of the signal lines;
using circuit data having the delay correction cells inserted to arrange the inserted delay correction cells in a vicinity of the corresponding output pads and to wire the signal lines between the respective delay correction cells and the corresponding output drivers to form a layout pattern;
using the layout pattern to calculate a resistance value of the signal lines;
correcting a resistance value of the delay correction cells so as to render the resistance values of the respective signal lines substantially equal to each other; and
using circuit data containing the delay correction cells having the resistance values corrected to correct a circuit pattern of the delay correction cells in the layout pattern.

2. The method in accordance with claim 1, wherein the delay correction cells are substantially identical in shape, size and circuitry with each other.

3. The method in accordance with claim 1, wherein the delay correction cell is a parameterized cell, which has a resistance value provided as a parameter so that only a pattern of an internal resistance element is altered without any change in contour and size.

4. The method in accordance with claim 4, wherein the parameterized cell comprises a resister and a buffer connected in series to each other, the resister having a resistance value as a parameter.
